(19) United States
(12) Patent Application Publication
(10) Pub. No.: US 2025/0246767 A1
(43) Pub. Date: Jul. 31, 2025

(54) SYSTEMS AND METHODS FOR ACHIEVING POSITIVE RETENTION BETWEEN BUS BAR MODULES AND BATTERY CELL GROUPINGS WITH TRACTION BATTERY PACKS

(71) Applicant: FORD GLOBAL TECHNOLOGIES, LLC, Dearborn, MI (US)

(72) Inventor: Marc DUGAS, Wixom, MI (US)

(21) Appl. No.: 18/425,069

(22) Filed: Jan. 29, 2024

(51) Int. Cl. H01M 50/516; H01M 50/204; H01M 50/249; H01M 50/503; H01M 50/507

(52) U.S. Cl. CPC H01M 50/516; H01M 50/204; H01M 50/249; H01M 50/503; H01M 50/507; H01M 2220/20

(57) ABSTRACT

Bus bar modules are provided for electrically connecting battery cells of a traction battery pack. An exemplary bus bar module may include a plurality of weldable insets. The weldable insets may provide attachment points for retaining the bus bar module to a grouping of battery cells when assembling a battery system of the traction battery pack. The weldable insets may establish a load transfer path directly to housings of the battery cells.

### TECHNICAL FIELD

This disclosure relates generally to traction battery packs, and more particularly to retaining bus bar modules to battery cell groupings within traction battery packs.

### BACKGROUND

Electrified vehicles include a traction battery pack for powering electric machines and other electrical loads of the vehicle. Traction battery packs include a plurality of battery cells. The battery cells must be reliably connected to one another in order to provide the voltage and power levels necessary for achieving vehicle electrical propulsion.

### SUMMARY

A traction battery pack according to an exemplary aspect of the present disclosure includes, among other things, a grouping of battery cells, a bus bar module arranged to electrically connect the grouping of battery cells, and a weldable inset held within a frame of the bus bar module and configured to provide an attachment point for retaining the bus bar module to the grouping of battery cells.

In a further non-limiting embodiment of the foregoing traction battery pack, a weld secures the weldable inset directly to a housing of a first battery cell of the grouping of battery cells.

In a further non-limiting embodiment of either of the foregoing traction battery packs, the weldable inset is secured directly to a top surface of the housing by the weld.

In a further non-limiting embodiment of any of the foregoing traction battery packs, the weld is a laser weld.

In a further non-limiting embodiment of any of the foregoing traction battery packs, a plurality of additional weldable insets are held within the frame and are each configured to provide an additional attachment point for retaining the bus bar module to the grouping of battery cells.

In a further non-limiting embodiment of any of the foregoing traction battery packs, the weldable inset is a metallic disk-like structure.

In a further non-limiting embodiment of any of the foregoing traction battery packs, the weldable inset is structurally joined to the frame.

In a further non-limiting embodiment of any of the foregoing traction battery packs, the weldable inset is located between a first row of bus bars and a second row of bus bars of the bus bar module.

In a further non-limiting embodiment of any of the foregoing traction battery packs, an adhesive is disposed between the bus bar module and the grouping of battery cells.

In a further non-limiting embodiment of any of the foregoing traction battery packs, the weldable inset establishes load transfer path directly to a housing of a first battery cell of the grouping of battery cells.

A traction battery pack according to another exemplary aspect of the present disclosure includes, among other things, a grouping of battery cells including a first battery cell and a second battery cell. A bus bar module is arranged to electrically connect the grouping of battery cells. A first weldable inset is held within a frame of the bus bar module and is configured to establish a first load transfer path directly to a first housing of the first battery cell, and a second weldable inset is held within the frame and is configured to provide a second load transfer path directly to a second housing of the second battery cell.

In a further non-limiting embodiment of the foregoing traction battery pack, a third weldable inset is held with the frame and is configured to establish a third load transfer path directly to the first housing of the first battery cell.

In a further non-limiting embodiment of either of the foregoing traction battery packs, each of the first weldable inset and the second weldable inset is configured to provide an additional attachment point for retaining the bus bar module to the grouping of battery cells.

In a further non-limiting embodiment of any of the foregoing traction battery packs, a first weld secures the first weldable inset directly to the first housing of the first battery cell, and a second weld secures the second weldable inset directly to the second housing of the second battery cell.

In a further non-limiting embodiment of any of the foregoing traction battery packs, the first weld and the second weld are laser welds.

In a further non-limiting embodiment of any of the foregoing traction battery packs, the first weldable inset is secured directly to a first top surface of the first housing, and the second weldable inset is secured directly to a second top surface of the second housing.

In a further non-limiting embodiment of any of the foregoing traction battery packs, the first weldable inset and the second weldable inset are configured as metallic disk-like structures.

In a further non-limiting embodiment of any of the foregoing traction battery packs, the first weldable inset is located between a first row of bus bars and a second row of bus bars of the bus bar module.

In a further non-limiting embodiment of any of the foregoing traction battery packs, the second weldable inset is located between a third row of bus bars and a fourth row of bus bars of the bus bar module.

A method for assembling a battery system of a traction battery pack according to another exemplary aspect of the present disclosure includes, among other things, positioning a bus bar module relative to a grouping of battery cells, and welding a weldable inset of the bus bar module to a housing of at least one battery cell of the grouping of battery cells.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates select portions of a traction battery pack.

FIG. 3 illustrates a battery system for a traction battery pack.

FIG. 4 is an exploded view of the battery system of FIG. 3.

FIG. 5 is a cross-sectional view through section 5-5 of FIG. 3.

FIG. 6 illustrates another exemplary battery system for a traction battery pack.

FIG. 7 is an exploded view of the battery system of FIG. 6.

FIG. 8 is a cross-sectional view through section 8-8 of FIG. 6.

### DETAILED DESCRIPTION

This disclosure details bus bar modules for electrically connecting battery cells of a traction battery pack. An exemplary bus bar module may include a plurality of weldable insets. The weldable insets may provide attachment points for retaining the bus bar module to a grouping of battery cells when assembling a battery system of the traction battery pack. The weldable insets may establish a load transfer path directly to housings of the battery cells. These and other features are discussed in greater detail in the following paragraphs of this detailed description.

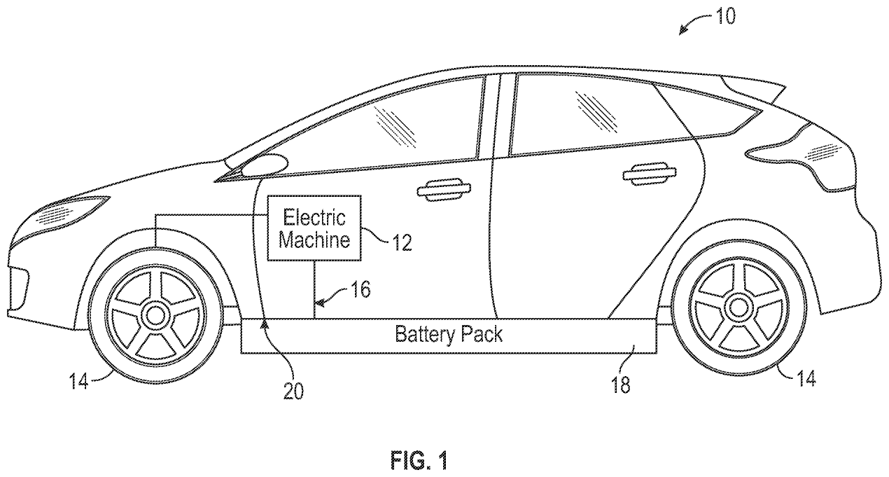

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

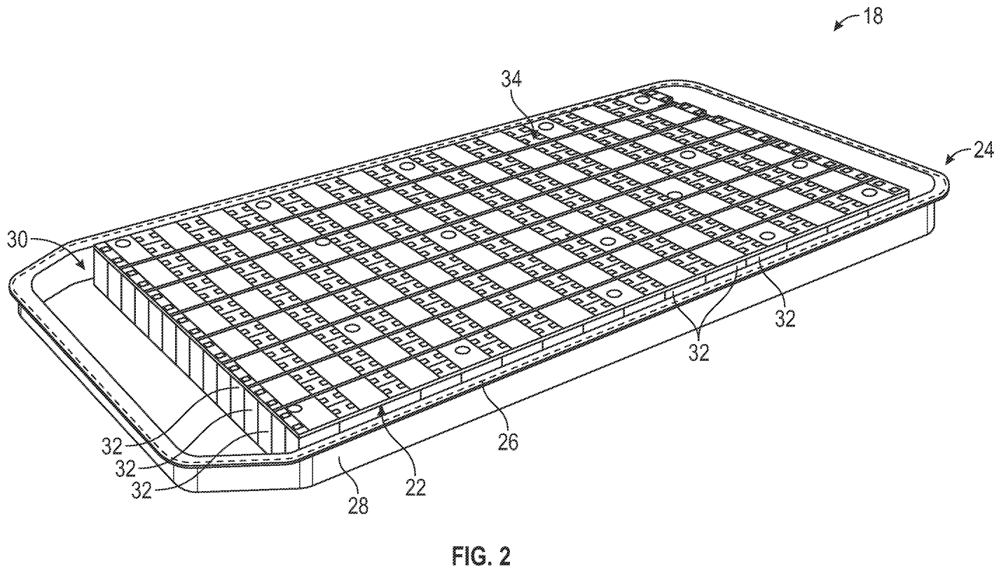

Referring now to FIG. 2, the traction battery pack 18 may include a battery system 22 housed within an interior area 30 of an enclosure assembly 24. The enclosure assembly 24 of the traction battery pack 18 may include an enclosure cover 26 (shown schematically) and an enclosure tray 28. The enclosure cover 26 may be secured (e.g., bolted, welded, adhered, etc.) to the enclosure tray 28 to provide the interior area 30 for housing the battery system 22. The overall size, shape, and configuration of the enclosure assembly 24 is not intended to limit this disclosure.

The battery system 22 may include one or more groupings of battery cells 32 and a bus bar module 34 arranged to electrically connect the battery cells 32. Once electrically coupled by the bus bar module 34, the battery cells 32 may supply the electrical power necessary for achieving electrical propulsion of the electrified vehicle 10.

In an embodiment, the battery cells 32 are arranged in a single, large format battery cell grouping, which may sometimes be referred to as a cell matrix. However, other configurations are also possible. For example, the battery cells 32 could alternatively be grouped together into two or more individual battery arrays/modules.

The total number of battery cells 32 included as part of the battery system 22 is not intended to limit this disclosure.

In an embodiment, the battery cells 32 are prismatic, lithium-ion cells. However, battery cells having other geometries (cylindrical, pouch, etc.) and/or chemistries (nickel-metal hydride, lead-acid, etc.) could alternatively be utilized within the scope of this disclosure.

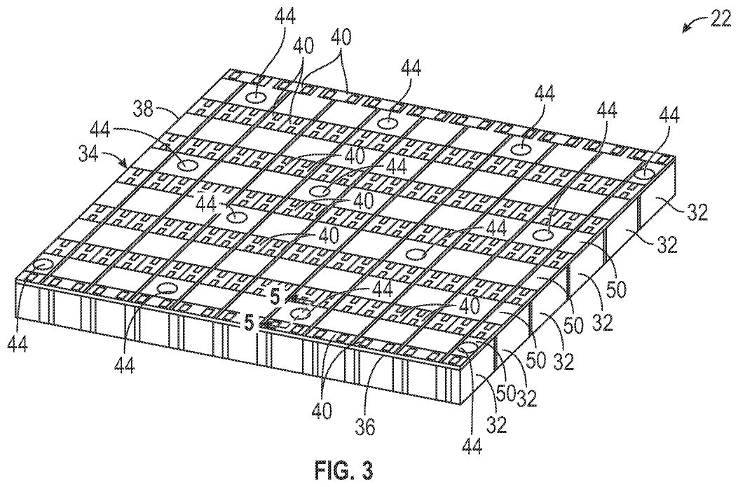

FIGS. 3, 4, and 5 illustrate additional details associated with the battery system 22 of the traction battery pack 18 of FIGS. 1 and 2. The bus bar module 34 may be arranged to extend in span across top surfaces 36 of the battery cells 32. However, other configurations are also contemplated within the scope of this disclosure.

In some implementations, the bus bar module 34 may eliminate the need for array-to-array interconnects. The size of the bus bar module 34 is scalable to address various manufacturing and packaging requirements of the traction battery pack 18.

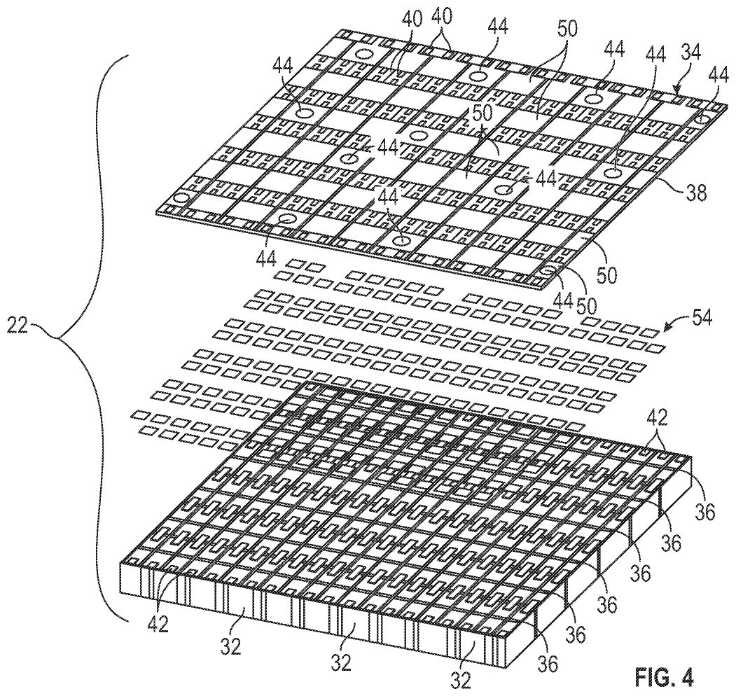

The bus bar module 34 may include a frame 38 and a plurality of bus bars 40 held within the frame 38. When the bus bar module 34 is positioned over the battery cells 32, the bus bars 40 may be positioned relative to terminals 42 (best shown in FIG. 4) of the battery cells 32. The bus bar module 34 therefore locates the bus bars 40 at the proper position for securing (e.g., welding) the bus bars 40 to the terminals 42 for electrically connecting the battery cells 32. Each bus bar 40 may electrically connect a pair of terminals 42 of adjacent battery cells 32. The total number of bus bars 40 provided by the bus bar module 34 may vary and could depend on the number of battery cells 32 provided within the battery system 22, among various other factors. The bus bar module 34 is therefore not limited to the specific configuration shown in FIGS. 3-5.

The bus bars 40 may be metallic components of the bus bar module 34, and the frame 38 may be a plastic component of the bus bar module 34. In an embodiment, the bus bars 40 are made of copper or aluminum, and the frame 38 is made of polypropylene or polyethylene. However, other materials could be utilized within the scope of this disclosure. The bus bars 40 may be stamped, relatively thin strips of metal that are configured to conduct the power stored by the battery cells 32.

The bus bar module 34 may additionally include a plurality of weldable insets 44 held within the frame 38. The total number of weldable insets 44 provided as part of the bus bar module 34 can vary and may depend on factors such as the amount of space between the battery cells 32, among various other factors.

The weldable insets 44 may be structurally joined to the frame 38 of the bus bar module 34. In an embodiment, the weldable insets 44 are adhered to the frame 38. In another embodiment, the frame 38 is overmolded around each weldable inset 44. However, other methodologies could be utilized to structurally join the weldable insets 44 to the frame 38.

Each weldable inset 44 may be configured as a metallic disk-like structure. In an embodiment, the weldable insets 44 are made of aluminum or steel. However, the size, shape, and material make-up of the weldable insets 44 are not intended to limit this disclosure.

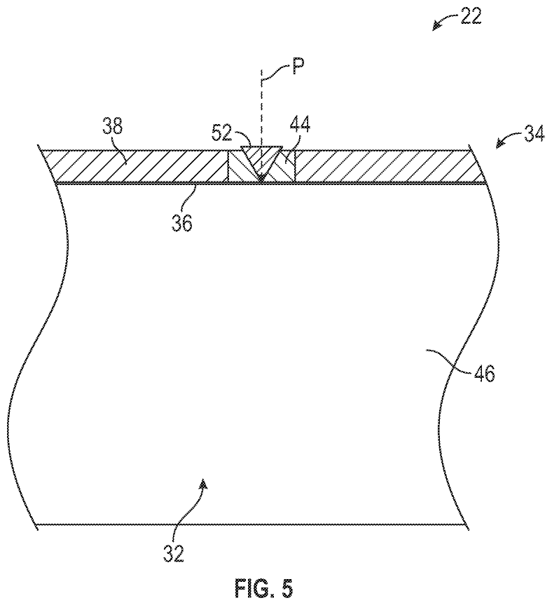

The specific placement of the weldable insets 44 within the frame 38 can be selected in order to position each weldable inset 44 in direct alignment with a housing 46 (see FIG. 5) of one of the battery cells 32 when the bus bar module 34 is received over the grouping of battery cells 32. In an embodiment, each weldable inset 44 is positioned to directly align with a top surface 36 of the housing 46 of one of the battery cells 32 when the bus bar module 34 is received over the grouping of battery cells 32. However, other configurations are contemplated within the scope of this disclosure.

In an embodiment, the weldable insets 44 are disposed within sections 50 of the frame 38 that extend between adjacent rows of the bus bars 40. Multiple weldable insets 44 may be provided within each of the sections 50.

Each weldable inset 44 may establish an attachment point for joining the bus bar module 34 to the grouping of battery cells 32. For example, each weldable inset 44 may be directly joined to the housing 46 of one of the battery cells 32 by one or more welds 52 (see FIG. 5). In an embodiment, the welds 52 are laser welds formed during a laser welding process. However, other welding processes could be utilized within the scope of this disclosure.

Once welding is complete, the weldable insets 44 may establish a load transfer path P that extends directly to the housings 46 of a portion of the battery cells 32 of the grouping of battery cells 32. In an embodiment, the weldable insets 44 provide load transfer directly to the top surfaces 36 of the battery cells 32.

One or more strips of adhesive 54 (see FIG. 4) may be disposed between the bus bar module 34 and the battery cells 32. The adhesive 54 may function to augment the fixation provided by the welds 52. The adhesive 54 may be an epoxy based adhesive or a urethane based adhesive, for example. However, the specific material properties of the adhesive 54 is not intended to limit this disclosure.

The embodiment shown in FIGS. 3-5 illustrates a minimum retention use case in which the total number of weldable insets 44 can be minimized and used to hold the bus bar module 34 in position relative to the battery cells 32 while the adhesive 54 cures. Use of the weldable insets 44 can reduce manufacturing times of the battery system 22 by eliminating the need for clamp on press devices, curing rack storage devices, and/or other assembly process controls.

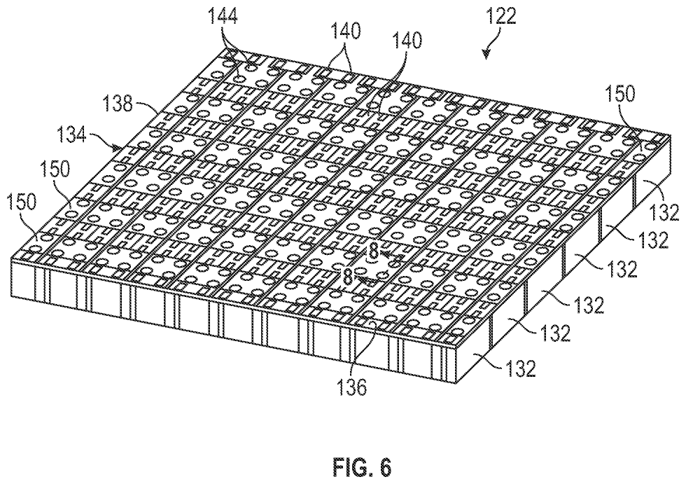

FIGS. 6, 7, and 8 illustrate another exemplary battery system 122 that can be utilized within the traction battery pack 18 of FIGS. 1 and 2. The battery system 122 may include one or more groupings of battery cells 132 and a bus bar module 134 arranged to electrically connect the battery cells 132. The bus bar module 134 may be arranged to extend in span across top surfaces 136 of the battery cells 132. However, other configurations are also contemplated within the scope of this disclosure.

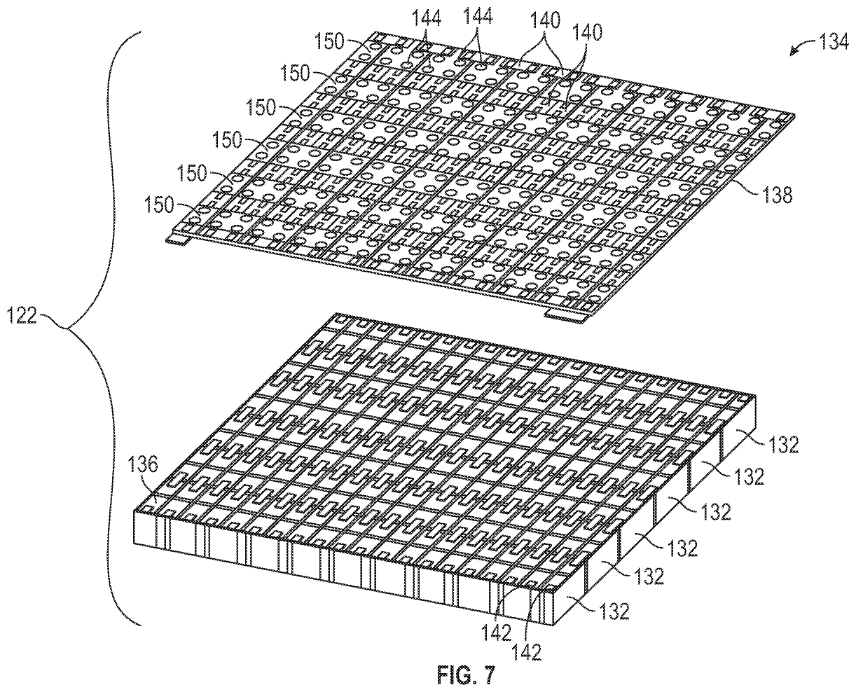

The bus bar module 134 may include a frame 138 and a plurality of bus bars 140 held within the frame 138. When the bus bar module 134 is positioned over the battery cells 132, the bus bars 140 may be positioned relative to terminals 142 (see FIG. 7) of the battery cells 132. The bus bar module 134 therefore locates the bus bars 140 at the proper position for securing (e.g., welding) the bus bars 140 to the terminals 142 for electrically connecting the battery cells 132. Each bus bar 140 may electrically connect a pair of terminals 142 of adjacent battery cells 132. The total number of bus bars 140 provided by the bus bar module 134 may vary and could depend on the number of battery cells 132 provided within the battery system 122, among various other factors. The bus bar module 134 is therefore not limited to the specific configuration shown in FIGS. 6-8.

The bus bars 140 may be metallic components of the bus bar module 134, and the frame 138 may be a plastic component of the bus bar module 134. In an embodiment, the bus bars 140 are made of copper or aluminum, and the frame 138 is made of polypropylene or polyethylene. However, other materials could be utilized within the scope of this disclosure. The bus bars 140 may be stamped, relatively thin strips of metal that are configured to conduct the power stored by the battery cells 132.

The bus bar module 134 may additionally include a plurality of weldable insets 144 held within the frame 138. The total number of weldable insets 144 provided as part of the bus bar module 134 can vary and may depend on factors such as the amount of battery cells 132 provided within the battery cell grouping, among various other factors.

The weldable insets 144 may be structurally joined to the frame 138. In an embodiment, the weldable insets 144 are adhered to the frame 138. In another embodiment, the frame 138 is overmolded around each weldable inset 144. However, other methodologies could be utilized to structurally join the weldable insets 144 to the frame 138.

Each weldable inset 144 may be configured as a metallic disk-like structure. In an embodiment, the weldable insets 144 are made of aluminum or steel. However, the size, shape, and material make-up of the weldable insets 144 are not intended to limit this disclosure.

The specific placement of the weldable insets 144 within the frame 138 can be selected in order to position each weldable inset 144 in direct alignment with a housing 146 of one of the battery cells 132 when the bus bar module 134 is received over the grouping of battery cells 132. In an embodiment, each weldable inset 144 is positioned to directly align with the top surface 136 of the housing 146 of one of the battery cells 132 when the bus bar module 134 is received over the grouping of battery cells 132. In another embodiment, multiple (e.g., two or more) weldable insets 144 are positioned to directly align with the top surface 136 of the housing 146 of each of the battery cells 132 when the bus bar module 134 is received over the grouping of battery cells 132. However, other configurations are contemplated within the scope of this disclosure.

In an embodiment, the weldable insets 144 are disposed within sections 150 of the frame 138 that extend between adjacent rows of the bus bars 140. A plurality of the weldable insets 144 may be provided within each of the sections 150.

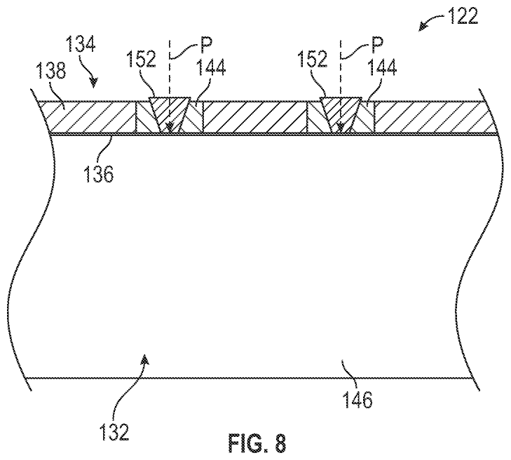

Each weldable inset 144 may establish an attachment point for joining the bus bar module 134 to the grouping of battery cells 132. Each weldable inset 144 can be directly joined to the respective housing 146 of one of the battery cells 132 by one or more welds 152 (see FIG. 8). In an embodiment, the welds 152 are laser welds formed during a laser welding process. However, other welding processes could be utilized within the scope of this disclosure.

Once welding is complete, the battery cells 132 are physically retained in position relative to one another. Moreover, the weldable insets 144 may establish a load transfer path P that extends directly to the housings 146 of battery cells 132. In an embodiment, the weldable insets 144 provide load transfer directly to the top surfaces 136 of the battery cells 132.

The embodiment of FIGS. 6-8 illustrates a maximum retention use case in which the total number of weldable insets 144 can be maximized and used to structurally join the bus bar module 134 to the grouping of battery cells 132 while allowing for the cell-to-cell transfer of forces through the weld-to-cell joint. Use of the weldable insets 144 can therefore eliminate the need for adhesive for retaining the battery cells 132 together, thereby substantially reducing manufacturing times and associated expenses.

The exemplary bus bar modules of this disclosure incorporate weldable insets for providing position retention and direct load paths relative to underlying battery cells. The bus bar modules are scalable for use with battery systems of all sizes and design requirements. The proposed solutions reduce manufacturing times and are less susceptible to manufacturing noise factors.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a grouping of battery cells;
a bus bar module arranged to electrically connect the grouping of battery cells; and
a weldable inset held within a frame of the bus bar module and configured to provide an attachment point for retaining the bus bar module to the grouping of battery cells.

2. The traction battery pack as recited in claim 1, comprising a weld that secures the weldable inset directly to a housing of a first battery cell of the grouping of battery cells.

3. The traction battery pack as recited in claim 2, wherein the weldable inset is secured directly to a top surface of the housing by the weld.

4. The traction battery pack as recited in claim 2, wherein the weld is a laser weld.

5. The traction battery pack as recited in claim 1, comprising a plurality of additional weldable insets held within the frame and each configured to provide an additional attachment point for retaining the bus bar module to the grouping of battery cells.

6. The traction battery pack as recited in claim 1, wherein the weldable inset is a metallic disk-like structure.

7. The traction battery pack as recited in claim 1, wherein the weldable inset is structurally joined to the frame.

8. The traction battery pack as recited in claim 1, wherein the weldable inset is located between a first row of bus bars and a second row of bus bars of the bus bar module.

9. The traction battery pack as recited in claim 1, comprising an adhesive disposed between the bus bar module and the grouping of battery cells.

10. The traction battery pack as recited in claim 1, wherein the weldable inset establishes load transfer path directly to a housing of a first battery cell of the grouping of battery cells.

11. A traction battery pack, comprising:
a grouping of battery cells including a first battery cell and a second battery cell;
a bus bar module arranged to electrically connect the grouping of battery cells;
a first weldable inset held within a frame of the bus bar module and configured to establish a first load transfer path directly to a first housing of the first battery cell; and
a second weldable inset held within the frame and configured to provide a second load transfer path directly to a second housing of the second battery cell.

12. The traction battery pack as recited in claim 11, comprising a third weldable inset held with the frame and configured to establish a third load transfer path directly to the first housing of the first battery cell.

13. The traction battery pack as recited in claim 11, wherein each of the first weldable inset and the second weldable inset is configured to provide an additional attachment point for retaining the bus bar module to the grouping of battery cells.

14. The traction battery pack as recited in claim 11, comprising a first weld that secures the first weldable inset directly to the first housing of the first battery cell and a second weld that secures the second weldable inset directly to the second housing of the second battery cell.

15. The traction battery pack as recited in claim 14, wherein the first weld and the second weld are laser welds.

16. The traction battery pack as recited in claim 11, wherein the first weldable inset is secured directly to a first top surface of the first housing, and the second weldable inset is secured directly to a second top surface of the second housing.

17. The traction battery pack as recited in claim 11, wherein the first weldable inset and the second weldable inset are configured as metallic disk-like structures.

18. The traction battery pack as recited in claim 11, wherein the first weldable inset is located between a first row of bus bars and a second row of bus bars of the bus bar module.

19. The traction battery pack as recited in claim 18, wherein the second weldable inset is located between a third row of bus bars and a fourth row of bus bars of the bus bar module.

20. A method for assembling a battery system of a traction battery pack, comprising:
positioning a bus bar module relative to a grouping of battery cells; and
welding a weldable inset of the bus bar module to a housing of at least one battery cell of the grouping of battery cells.
